(19) United States
(12) Patent Application Publication
(10) Pub. No.: US 2016/0236330 A1
(43) Pub. Date: Aug. 18, 2016

(54) Fastener-Tightened Bonnet Nut Wrench

(71) Applicant: Dustin Popejoy, Fairbury, IL (US)

(72) Inventor: Dustin Popejoy, Fairbury, IL (US)

(21) Appl. No.: 14/706,404

(22) Filed: May 7, 2015

Related U.S. Application Data
(60) Provisional application No. 62/116,131, filed on Feb. 13, 2015.

(51) Int. Cl. B25B 13/50

(52) U.S. Cl. CPC B25B 13/50

(57) ABSTRACT

A wrench adapted for use with bonnet nuts of shower valves. The present invention includes a substantially closed end wrench having a pair of disconnected distal ends separated by a gap. The distal ends each include a threaded aperture, each of which are aligned to allow a fastener to be inserted therethrough. As the fastener placed through the pair of complementary threaded apertures is tightened, it draws the distal ends together, thereby closing the head of the wrench. The present invention is used by placing the end of the wrench over the bonnet nut and then tightening the fastener in order to close the end of the wrench around the bonnet nut. The frictional engagement between the interior surface of the wrench end and the bonnet nut around which the closed end is tightened allows the user to apply torque to the wrench to tighten or loosen the bonnet nut.

### CROSS REFERENCE TO RELATED APPLICATION

This application claims the benefit of U.S. Provisional Application No. 62/116,131 filed on Feb. 13, 2015. The above identified patent application is herein incorporated by reference in its entirety to provide continuity of disclosure.

### FIELD OF THE INVENTION

The present invention relates to wrenches. More specifically, the present invention relates to wrenches adapted for use with various types of plumbing applications, such as with shower valves.

### BACKGROUND OF THE INVENTION

The bonnet nut of a bathtub and shower valve can be extremely difficult to remove. In particular, the threading of the bonnet nut can become locked with the threading of the valve body due to calcium buildup, the nut can be slick and difficult to grip with conventional wrenches, and the valve body must held steady simultaneously as the bonnet nut is turned. Furthermore, if users twist the valve body too much when attempting to remove the bonnet nut, it can potentially result in hundreds of dollars' worth of damage to the plumbing system that must be fixed by a professional. Bathtub and shower valves that utilize smooth, circular bonnet nuts are even more difficult to remove because of the difficulty associated with gripping the bonnet nut without causing damage to the body of the shower valve.

One technique to remove a bonnet nut from a valve body is by locking the valve body in place with one wrench and then using a second wrench to apply torque to the bonnet nut. However, it can be challenging to simultaneously hold both wrenches while ensuring that the valve body does not twist too much. Another technique to remove a bonnet nut is to apply heat, often using a rag laden with hot water, to the bonnet nut in order to loosen it. However, this is unreliable and can be very time consuming. Still yet another technique to remove a bonnet nut is to apply WD-40 or another such penetrating fluid to the threading between the valve body and the bonnet nut. However, penetrating fluid may not be sufficient to break the nut-body connection if there is a substantial amount of calcium buildup. Therefore, there is a need in the prior art for a device specifically adapted to remove bonnet nuts from bathtub and shower valve bodies, without causing damage to the valves.

### SUMMARY OF THE INVENTION

In view of the foregoing disadvantages inherent in the known types of wrenches now present in the prior art, the present invention provides a fastener-tightened bonnet nut wrench wherein the same can be utilized for providing convenience for the user when removing smooth, circular bonnet nuts from bathtub and shower valves. The present system comprises a substantially closed end wrench comprising a pair of disconnected distal ends separated by a gap. The distal ends each comprise a threaded aperture and each of the threaded apertures are aligned, thereby allowing a fastener to be inserted therethrough. As the fastener placed through the pair of complementary threaded apertures is tightened, it draws the distal ends together, thereby closing the end of the wrench. The present invention is used by placing the end of the wrench over the bonnet nut and then tightening the fastener in order to close the end of the wrench around the bonnet nut. The frictional engagement between the interior surface of the wrench end and the bonnet nut around which the closed end is tightened allows the user to apply torque to the wrench to tighten or loosen the bonnet nut.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention.

FIG. 2 shows a close up view of the tightening mechanism of the present invention.

FIG. 3A shows a cross-sectional view of the present invention along line 3A-3A with the head open.

FIG. 3B shows a cross-sectional view of the present invention along line 3B-3B with the head closed.

FIG. 4 shows a perspective view of the present invention secured to a valve.

FIG. 5 shows a perspective view of an alternative embodiment of the present invention.

FIG. 6 shows a cross-sectional view of the head of an alternative embodiment of the present invention along line 6-6.

### DETAILED DESCRIPTION OF THE INVENTION

Reference is made herein to the attached drawings. Like reference numerals are used throughout the drawings to depict like or similar elements of the fastener-tightened wrench. For the purposes of presenting a brief and clear description of the present invention, the preferred embodiment will be discussed as used for removing bonnet nuts from bathtub or shower valves that utilize smooth, circular bonnet nuts. The figures are intended for representative purposes only and should not be considered to be limiting in any respect.

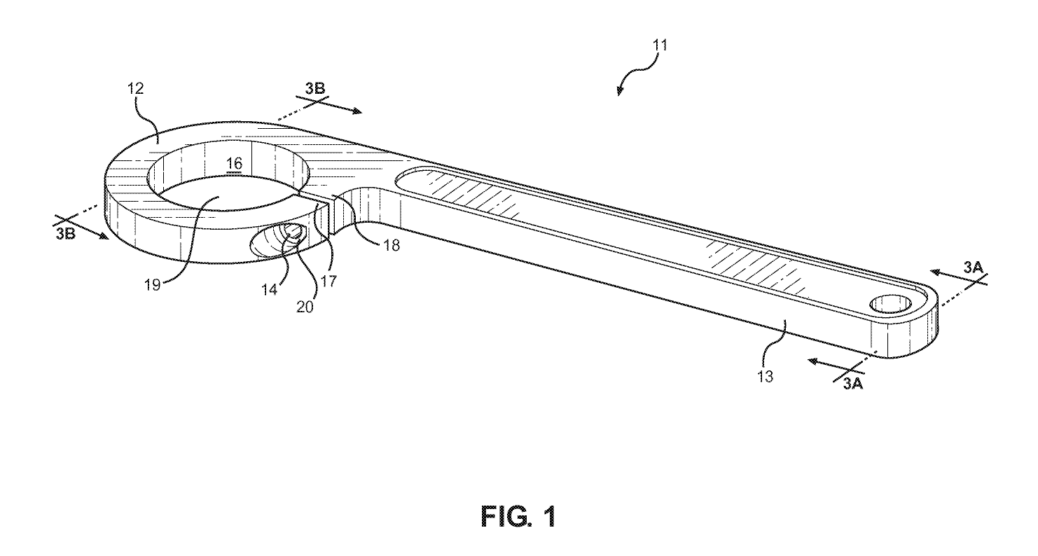

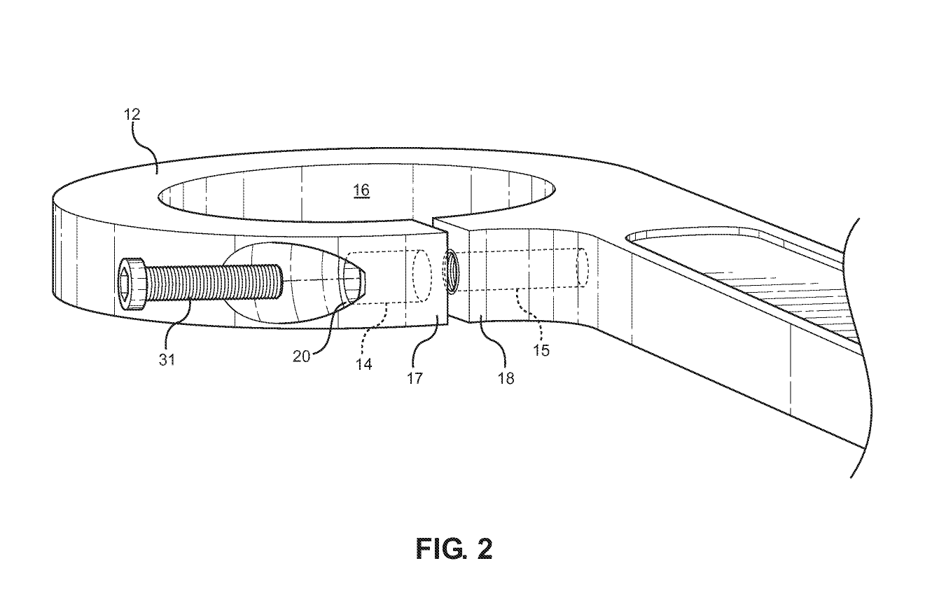

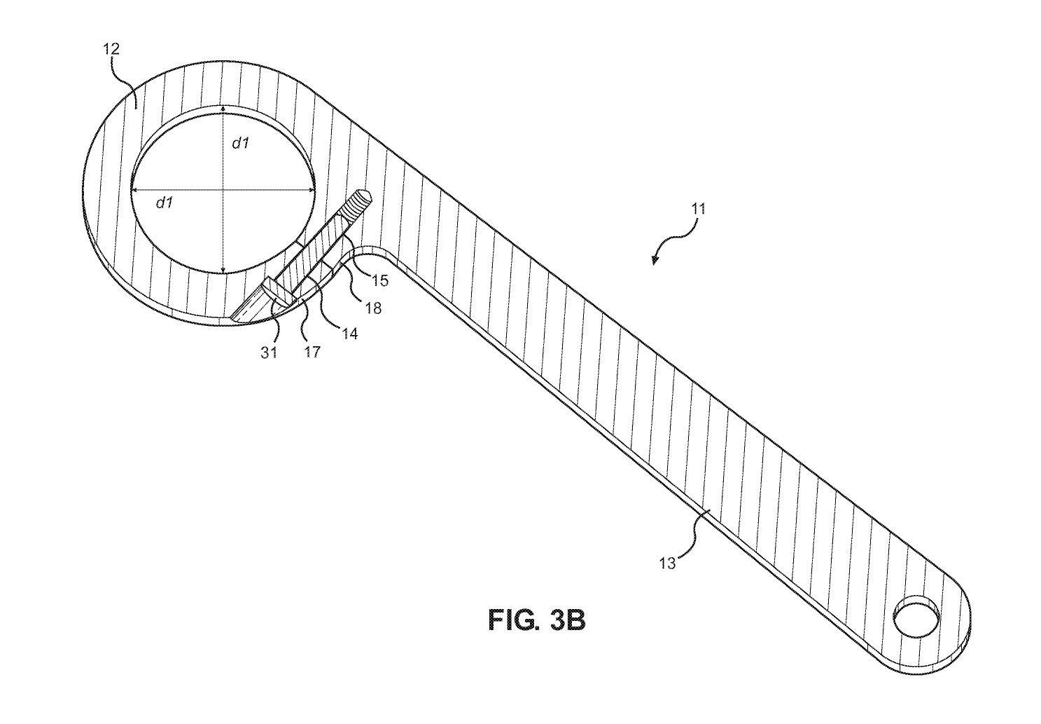

Referring now to FIGS. 1-4, there are shown various views of an embodiment of the present invention. The present invention is a wrench 11 comprising a body 13 and an arcuate member 12 extending around and back to the body 13, forming a substantially closed head 19 having an open interior. The arcuate member 12 comprises a distal end 17 that is separated by a gap from the body 13 of the wrench 11. The distal end 17 comprises a first aperture 14 and the body 13 comprises a threaded second aperture 15 extending therethrough. In an illustrative embodiment of the present invention, the second aperture 15 is disposed through a projection 18 extending from the body 13. In an alternative embodiment of the present invention, the second aperture 15 is disposed directly through the body 13, lacking a projection 18. The first and second apertures 14, 15 are aligned such that a fastener 31 can be inserted therethrough and engage with the threading of the second aperture 15. In one embodiment of the present invention, the fastener 31 comprises a fastener having a head adapted to engage with a hex key; however, no claim is made as to the specific fastener utilized by the present invention.

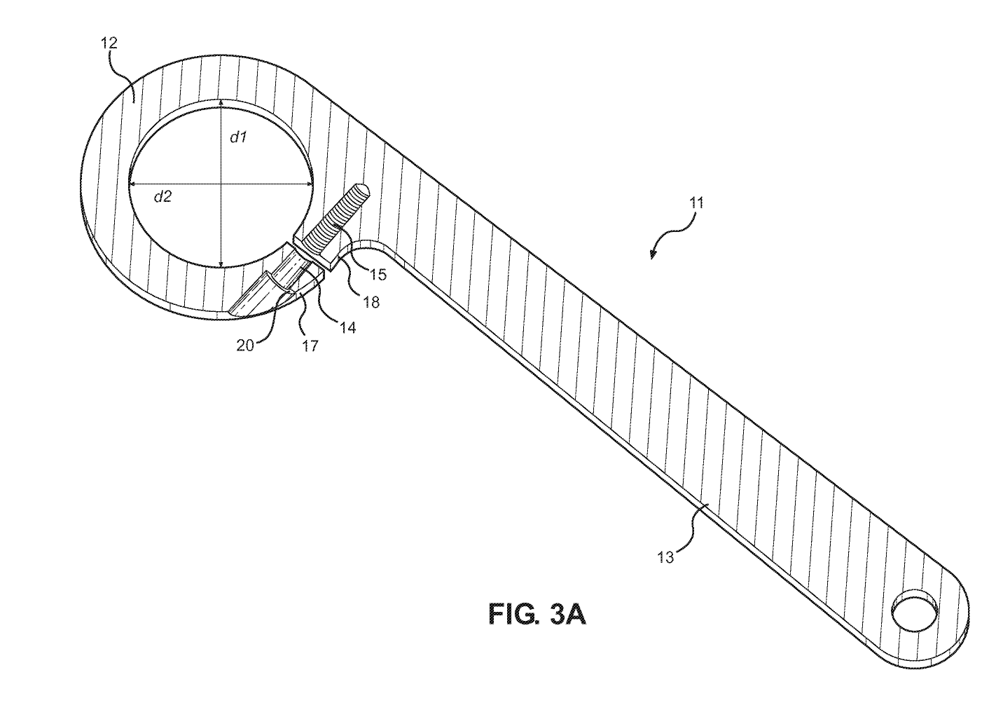

When the head 19 is in its open configuration, i.e. the distal end 17 and the projection 18 are in a spaced relationship as shown in FIG. 3A, the head 19 has a slightly non-circular shape, such that the distance d1 between a first set of opposing points and the distance d2 between a second set of opposing points are non-equal. When the fastener 31 is tightened, the threading of the fastener 31 engages with the complementary threading of the second aperture 15 and the head of the fastener 31 bears against the edge 20 extending around the open end of the first aperture 14. This draws the distal end 17 against the projection 18, securing the distal end 17 of the arcuate member 12 and the projection 18 extending from the body 13 together and thereby enclosing the head 19. When the head 19 is in its closed configuration, i.e. the faces of the distal end 17 and the projection 18 rest flush against each other due to the tightened fastener 31, the head 19 has a circular shape, such that the diameter d1 is constant. In an alternative embodiment of the present invention, the wrench 11 lacks a projection 18 extending from the wrench 11 to which the distal end 17 is drawn. Rather, the distal end 17 is drawn directly against the body 13. Finally, the head 19 may not be perfectly circular but has a rounded profile.

The face of the distal end 17 and the face of the projection 18 are adapted to rest flush against each other when the distal end 17 is drawn against the projection 18. The face of the distal end 17 is curved and the face of the projection 18 has a complementary curvature. In an illustrative embodiment of the present invention, the distal end 17 comprises a planar face and the projection 18 comprises a complementary planar face, wherein the angles at which the planar faces are disposed correspond to each other. The ability of the distal ends 17 and the projection 18 to rest flush against each other ensures that the head 19 is fully enclosed when tightened via the fastener 31.

The present invention is adapted for use with Delta R10000, Brizo R60000, Peerless R10000, and other such valves 21 having rounded, smooth-edged bonnet nuts 22. As such, the interior surface 16 of the head 19 is a smooth surface that is free from projections therefrom so that the interior surface 16 conforms to the bonnet nut 22 of the valves 21 and rests flush thereagainst when the head 19 is tightened. In use, the untightened head 19 of the present wrench 11 is placed around a bonnet nut 22 the user wishes to tighten or loosen a valve 21. Once in place, the user then tightens the fastener 31 through the apertures 14, 15 disposed through the distal ends 17 and the projection 18, which closes the head 19 around the bonnet nut 22. When fully tightened, the friction between the interior surface 16 of the head 19 and the peripheral edge of the bonnet nut 22 allows the user to tighten or loosen the bonnet nut 22 by actuating the wrench 11.

The wrench 11 is constructed from a material that is rigid enough to avoid bending when torque is applied thereto during use, but bendable enough such that tightening of the fastener 31 through the apertures 14, 15 is able to alter the shape of the head 19 by drawing the distal end 17 and the projection 18 against each other. In one embodiment of the present invention, the wrench 11 is fabricated from T6 temper 6061 aluminum alloy.

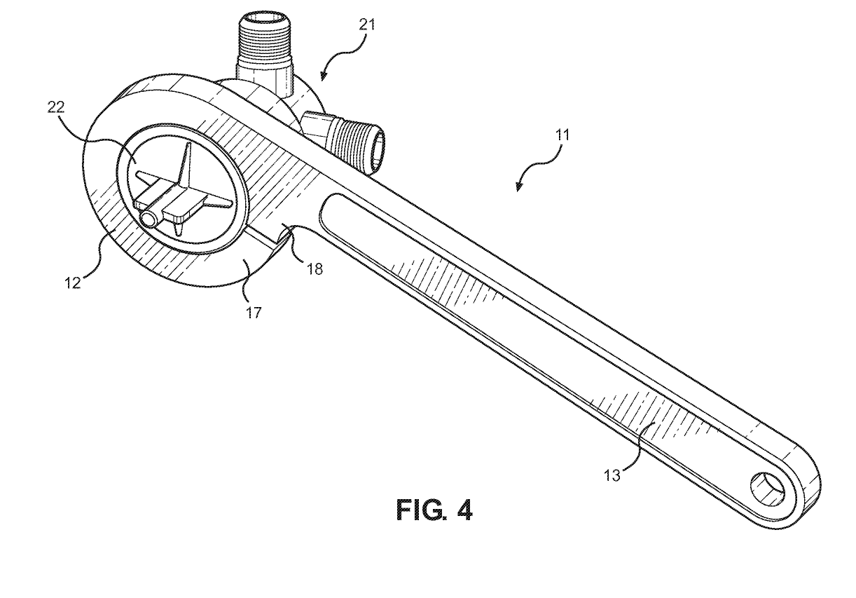

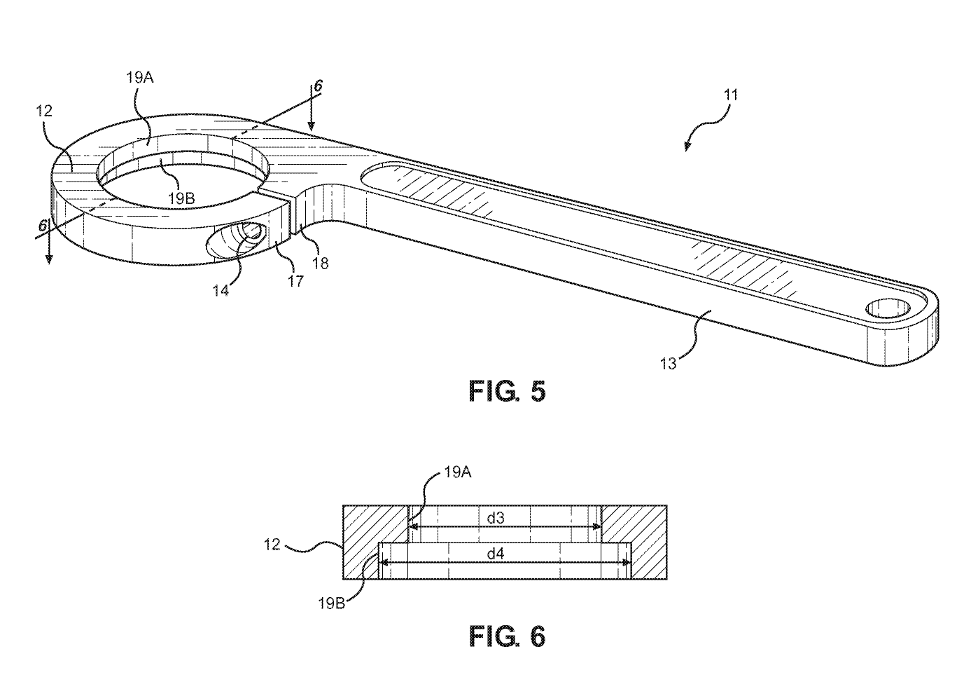

Referring now to FIGS. 5-6, there are shown a perspective view and a cross-sectional view of the head of an alternative embodiment of the present invention along line 6-6. In the depicted embodiment of the present invention, the head 19 comprises a first side 19A having a first diameter d3 and a second side 19B having a second diameter d4. As the size of bonnet nuts vary from model-to-model of shower valves, the opposing sides 19A, 19B of the head 19 allow the wrench 11 to be used with different models of valves.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wrench, comprising:
a body;
an arcuate member forming a substantially enclosed head with the body, the arcuate member comprising a distal end;
a first aperture disposed on the distal end;
a threaded second aperture disposed on the body;
wherein the first aperture and the threaded second aperture are aligned such that a fastener is securable therethrough;
wherein tightening of the fastener brings the distal end in contact with the body.

2) The wrench of claim 1, wherein the head is rounded in shape.

3) The wrench of claim 1, wherein an interior surface of the head is smooth.

4) The wrench of claim 1, wherein the fastener is adapted to be actuated by a hex key.

5) The wrench of claim 1, wherein the wrench is constructed from a material, the material comprising T6 temper 6061 aluminum alloy.

6) The wrench of claim 1, wherein the head comprises a first side comprising a first diameter and a second side comprising a second diameter.

7) The wrench of claim 1, wherein the head comprises a rounded, open interior with a non-uniform diameter.

8) The wrench of claim 1, wherein the distal end is adapted to rest flush against the second distal end when in contact therewith.

9) The wrench of claim 1, wherein a curvature of a face of the distal end is complementary of a curvature of a face of the body.

10) The wrench of claim 1, wherein the head forms a closed, rounded open interior adapted to engage a bonnet nut when tightened.

11) The wrench of claim 1, wherein the threaded second aperture is disposed on a projection extending from the body.
